(19) United States
(12) Patent Application Publication
(10) Pub. No.: US 2009/0010452 A1
(43) Pub. Date: Jan. 8, 2009

(54) ADAPTIVE NOISE GATE AND METHOD

(75) Inventors: Takahiro Unno, Richardson, TX (US); Fabien Ober, Villeneuve-Loubet (FR)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 12/166,404

(22) Filed: Jul. 2, 2008

Related U.S. Application Data
(60) Provisional application No. 60/948,227, filed on Jul. 6, 2007.

(51) Int. Cl. H04B 15/00

(52) U.S. Cl. 381/94.1; 704/225

(57) ABSTRACT

Speech noise gating for gain control functions such as automatic gain control, dynamic range compression, and digital volume control scales the gain control function gain according to the ratio of noise energy to input energy.

### CROSS-REFERENCE TO RELATED APPLICATIONS

This application claims priority from provisional application No. 60/948,227, filed Jul. 6, 2007. The following co-assigned co-pending patent applications disclose related subject matter: application Ser. No. 11/165,902, filed Jun. 24, 2005. All of which are herein incorporated by reference.

### BACKGROUND OF THE INVENTION

The present invention relates to signal processing, and more particularly to digital audio gain control devices and methods.

Speech gain control modules, such as Automatic Gain Controller (AGC), Dynamic Range Compressor (DRC), and Digital Volume Controller (DVC), are important items in mobile phone acoustic systems. Gain control modules can be implemented as Digital Baseband (DBB) software, Analog Baseband (ABB) hardware, or combinations of DBB software and ABB hardware. Gain control modules allow a handset terminal to provide a speech level sufficient for an ear-piece or loudspeaker output of the far-end (receiving or downlink) signal and for a near-end transmission signal (sending or uplink signal). However, background noise handling presents problems for gain control module design. Indeed, a gain control module may amplify background noise to undesirable levels and significantly degrade perceptual quality of handset terminal.

Generally, a speech gain control module can be described as illustrated in FIG. 2a as applying a gain to the input speech signal:

y(k)=G x(k)

where x(k) and y(k) are digital input and output of the gain control module, and G is the applied gain which is a constant in Digital Volume Control (DVC) and is a variable dependent upon the input signal in AGC and DRC.

Generally, DRC includes a fixed noise gate to avoid background noise amplification. DRC with a fixed noise gate typically applies a gain of 0 dB or less to the input signal when the input level is lower than a pre-determined threshold. However, it is difficult to select a fixed noise gate threshold that prevents background and idle channel noise amplification while properly amplifying low-level speech signals. Conventional AGC does not include a noise gate, but it is possible to integrate protection against excessive noise level amplification by using a Voice Activity Detector (VAD); see cross-referenced patent application Ser. No. 11/165,902. For example, the AGC described therein does not increase gain while the VAD decision is off (i.e., input signal is not speech). This prevents the AGC from excessively amplifying any background noise signal, but it allows the AGC to apply the same gain to speech and pause segments, and thus background noise level is still amplified.

The straightforward idea of completely avoiding noise level amplification is to apply gain to the input signal only during speech segments. However, this could cause two types of distortion. The first type of distortion is noise sputtering. It is difficult for a VAD to identify speech and noise without decision error. If a VAD makes a decision error during pause segments, the AGC amplifies the noise signal level in isolated short time intervals and will cause noise sputtering distortion. The second distortion is noise level difference between speech and pause segments. Background or idle channel noise is present even in speech segments. If gain is applied to the input signal only during speech segments, there will be a noise level gap between speech and pause segments. This gap would cause audible noise level fluctuation.

### SUMMARY OF THE INVENTION

The present invention provides adaptive noise gating for a speech gain control module by estimating noise and correspondingly scaling the gain.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 shows a system with adaptive noise gating.

FIGS. 2a-2c show a gain control module, a processor, and network communication.

### DESCRIPTION OF THE PREFERRED EMBODIMENTS

### 1. Overview

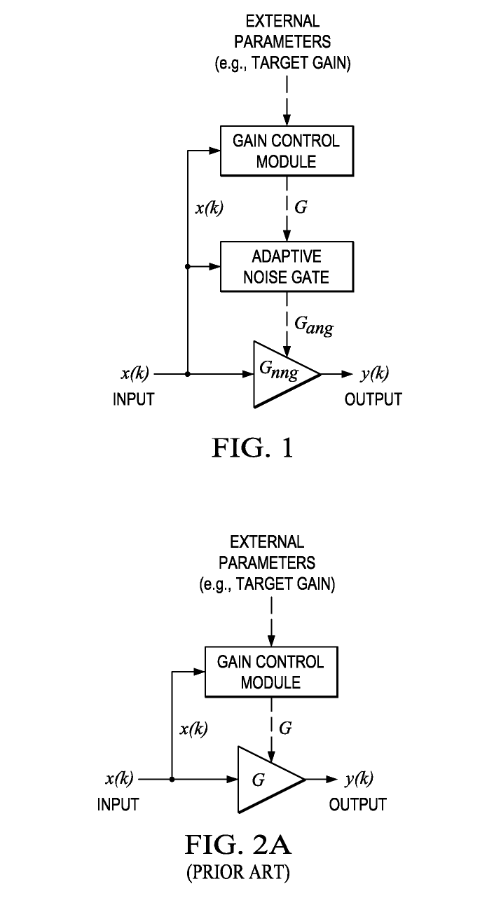

Preferred embodiment methods provide adjustment of the gain output by a gain control module to limit the amplification of noise (noise gating) by estimating the noise and correspondingly scaling the gain. FIG. 1 illustrates the adaptive noise gate applied to the output of a gain control module.

The preferred embodiment adaptive noise gate prevents background noise amplification during pause segments while preserving gain computed in a gain control module during speech segments. This is a post-processing module for gain control function, and applicable to any speech gain control functions.

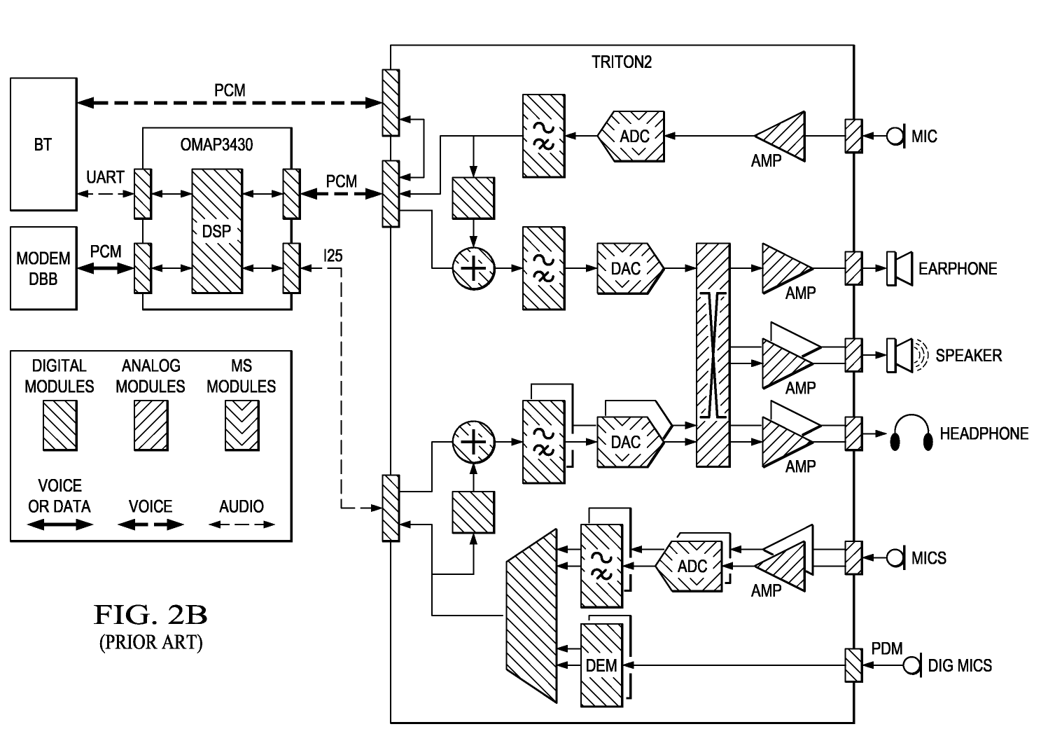

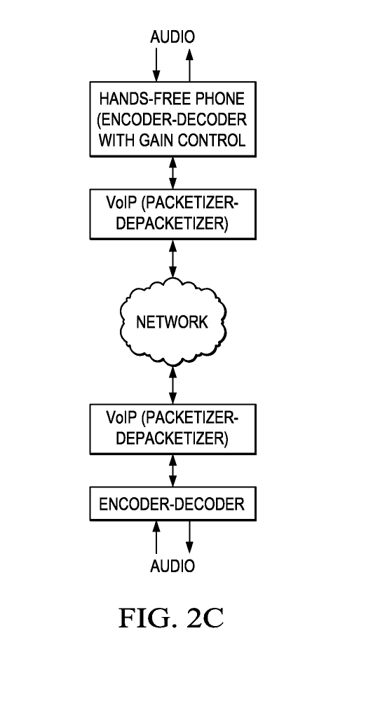

Preferred embodiment systems (e.g., hands-free cellphones, speakerphones, etc.) perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators. FIG. 2b shows functional blocks of an example of a mobile system capable of hands-free support. A stored program in an onboard or external (flash EEP)ROM or FRAM could implement the signal processing. Analog-to-digital converters and digital-to-analog converters can provide coupling to the real world, modulators and demodulators (plus antennas for air interfaces) can provide coupling for transmission waveforms, and packetizers can provide formats for transmission over networks such as packetized over the Internet (VoIP); see FIG. 2c.

### 2. Adaptive Noise Gating

Initially consider FIG. 2a which shows a generic block diagram of a gain control module. The gain control module could be AGC, DRC, DVC, or any function that determines gain G with a given input signal x(k) and external parameter(s) such as target output level or pre-determined constant gain. Then, gain G computed in gain control function is applied to the input signal x(k). The notation is for digital speech, such as sampled at 8 or 16 kHz with 8-, 12-, or 16-bit data and partitioned into 10 or 20 ms frames (e.g., 80, 160, or 320 samples). A sum of the squares of a signal over a frame provides an energy measurement of the signal.

In contrast to the gain control module system in FIG. 2a, a preferred embodiment system has a gain control module together with an adaptive noise gate for the output of the gain control module; FIG. 1 shows a block diagram. As shown in the figure, the adaptive noise gate is a separate post-processing module from the gain control module. The noise gate modifies gain G from the gain control module into G_{ang} applied to a given input signal to avoid background or idle channel noise amplification during pause segments.

Gain control module without an adaptive noise gate as shown in FIG. 2a applies gain G to input signal x(k) which is the sum of a speech signal s(k) and a noise signal n(k). This means that gain G is applied to both the speech and the noise signals, and thus the output y(k) is:

$$\begin{matrix}y ( k ) = Gx ( k ) \\ = G ( s ( k ) + n ( k ) ) \\ = Gs ( k ) + Gn ( k )\end{matrix}$$

However, the adaptive noise gate function modifies G to G_{ang} so that gain G is effectively only applied to the speech signal s(k). In particular, requiring both

y(k)=G_{ang}x(k)

and

y(k)=G s(k)+n(k)

gives

G_{ang}x(k)=G s(k)+n(k)

Next, taking expectations of the energies gives:

G_{ang}² E[x(k)²]=G² E[s(k)²]+2G E[s(k) n(k)]+E[n(k)²]

Then assuming that the speech and noise signals are statistically de-correlated (i.e., E[s(k) n(k)]=0) implies

G_{ang}² E[x(k)²]=G² E[s(k)²]+E[n(k)²]

Finally, recalling x(k)=s(k)+n(k), and thus E[x(k)²]=E[s(k)²]+E[n(k)²], allows for elimination of the E[s(k)²] term:

G_{ang}²E[x(k)²]=G²(E[x(k)²]−E[n(k)²])+E[n(k)²]

Simplifying notation by writing Eₓ=E[x(k)²] and Eₙ=E[n(k)²] gives

G_{ang}² Eₓ=G²(Eₓ−Eₙ)+Eₙ

and thus dividing by Eₓ:

$$\begin{matrix}{G}_{ang}^{2} = {G}^{2} ( 1 - {E}_{n} / {E}_{x} ) + {E}_{n} / {E}_{x} \\ = {G}^{2} + ( 1 - {G}^{2} ) {E}_{n} / {E}_{x}\end{matrix}$$

or taking square roots:

G_{ang}=[G²+(1−G²)Eₙ/Eₓ]^{1/2}

Because Eₓ and Eₙ are estimated, the inequality Eₙ≦Eₓ (i.e., 0≦Eₛ) may not hold for the estimates, so take:

$$\begin{matrix}{G}_{ang} = {[ {G}^{2} + ( 1 - {G}^{2} ) {E}_{n} / {E}_{x} ]}^{1 / 2} & if {E}_{n} < {E}_{x} \\ = 1.0 & otherwise\end{matrix}$$

The noise level Eₙ can be estimated with the input signal x(k) in many different ways. First preferred embodiments used the noise level estimation method described in the cross-referenced patent application Ser. No. 11/165,902 in which the noise level is estimated with asymmetric time constants: slow upward time constant Cᵤ and fast downward time constant C_{d}. The following is pseudocode for this noise estimation method.

```
if (Eₓ > Eₙ * Cᵤ)
    Eₙ = Eₙ * Cᵤ
else if (Eₓ < Eₙ * C_{d})
    Eₙ = Eₙ * C_{d}
else
    Eₙ = Eₓ
```

Example values are C_{d}=0.895 (so with 20 ms frames, a decrease of −24 dB/s) and Cᵤ=1.014 (again with 20 ms frames, an increase of 3 dB/s).

In summary, the first preferred embodiment adaptive noise gating for a gain control function (gain control module output) includes the steps of:

(a) estimating noise energy;

(b) estimating input signal energy; and

(c) adjusting a gain, G, by adjusting G² to G²+(1−G²)R where R is the ratio of said estimated noise energy divided by said estimated input energy.

### 3. Noise Fluctuations

Under high-level background noise conditions (e.g. noise SNR is 10 dB or lower), the first preferred embodiment adaptive noise gate introduces audible noise fluctuations due to the noise level gap between speech and pause segments (the noise level remains high during speech, but is reduced to low levels during pause segments). The second preferred embodiments handle noise fluctuations by automatically disabling the adaptive noise gate for high-level background noise conditions without binary switching artifacts.

In particular, pick two noise level thresholds T_H and T_L(T_H>T_L) expressed in dB for the noise fluctuation handling process. Then, depending on input background noise level Eₙ, apply either adaptive noise gate gain G_{ang}, original gain G, or an interpolated value of G_{ang} and G, to the input signal. The following is pseudo code of an implementation.

```
if 10*log10(Eₙ) < T_L
    G′ = G_{ang}
else if 10*log10(Eₙ) > T_H
    G′ = G
else
    w = (10*log10(Eₙ) − T_L) / (T_H − T_L)
    G′ = w * G + (1 − w) * G_{ang}
```

where G′ is the gain applied to the input signal. As shown above, adaptive noise gate gain G_{ang} is used if the background noise level is low because the noise level gap between speech and pause is not very audible. If background noise level is high, the original gain from the gain control module, G, is used to avoid noise fluctuations. Finally, if background noise level falls between T_L and T_H, an interpolated gain of G_{ang} and G will be used. This allows the noise fluctuation handling process to smoothly disable an adaptive noise gate depending on background noise level.

In one implementation, T_H and T_L were set to −20 dBm0 and −50 dBm0 (or −26 dBFS and −56 dBFS), respectively.

### 4. Pause Segment Noise Reduction

The adaptive noise gate does not apply gain (or applies gain of 0 dB) to the input signal when Eₓ≦Eₙ (i.e., during pause segments). If an application requires suppressing the noise level to some extent, then the foregoing can be re-formulated as follows where α<1 is a noise suppression factor.

G_{ang}² Eₓ=G²(Eₓ−Eₙ)+α² Eₙ

And then the modified adaptive noise gated gain can be derived as follows.

$$\begin{matrix}{G}_{ang}^{2} = {G}^{2} ( 1 - {E}_{n} / {E}_{x} ) + {α}^{2} {E}_{n} / {E}_{x} \\ = {G}^{2} + ( {α}^{2} - {G}^{2} ) {E}_{n} / {E}_{x}\end{matrix}$$

or taking square roots:

G_{ang}=[G²+(α²−G²)Eₙ/Eₓ]^{1/2}

In one implementation, α is set to −3 dB (i.e. α=10^{(-3*0.05)}). Note that, if α is set very low (e.g. −6 dB or lower), it will cause audible noise fluctuation artifacts.

### 5. Modifications

The adaptive noise gate is an independent post-processing module for a gain control module (gain control function). It can be applied to any speech gain control functions such as DRC, AGC, digital volume control, etc. The method does not depend on signal sampling rate, so it can be applied to 8 kHz, 16 kHz or any other sampling rate. The various constants and thresholds described in the preferred embodiments can be replaced with other reasonable values. Other background noise estimation methods can be used, such as simple smoothing. The adaptive noise gate can be applied with or without noise fluctuation handling and/or background noise level reduction.

While the foregoing is directed to embodiments of the present invention, other and further embodiments of the invention may be devised without departing from the basic scope thereof, and the scope thereof is determined by the claims that follow.

What is claimed is:

1. A method of gain control, comprising the steps of:
(a) estimating noise energy;
(b) estimating input signal energy; and
(c) adjusting a gain G for said input signal to an adjusted gain G_{ang} for said input signal where G_{ang}² equals G²+(1−G²)R where R is the ratio of said estimated noise energy divided by said estimated input signal energy.

2. The method of claim 1, wherein when said R is greater than 1, said G_{ang} is taken equal to 1.

3. The method of claim 1, wherein when said estimated noise energy is greater than a low threshold and less than a high threshold, interpolating said G and said G_{ang} to yield a modified gain for said input signal.

4. A method of gain control and echo suppression, comprising the steps of:
(a) estimating noise energy;
(b) estimating input signal energy;
(c) providing a noise suppression factor α; and
(d) adjusting a gain G for said input signal to an adjusted gain G_{ang} for said input signal where G_{ang}² equals G²+(α²−G²)R where R is the ratio of said estimated noise energy divided by said estimated input signal energy.

5. An audio system, comprising:
(i) an input for a audio signal;
(ii) an output;
(iii) an amplifier connected between said input and said output;
(iv) a gain control module connected to said input; and
(v) an adaptive noise gate between said gain control module and said amplifier, said adaptive noise gate operable to:
(a) estimate noise energy of an input signal at said input;
(b) estimate input signal energy of said input signal; and
(c) adjust a gain G output by said gain control module for said input signal to an adjusted gain G_{ang} for said input signal where G_{ang}² equals G²+(1−G²)R where R is the ratio of said estimated noise energy divided by said estimated input signal energy.
